(19) United States
(12) Patent Application Publication
(10) Pub. No.: US 2002/0127295 A1
(43) Pub. Date: Sep. 12, 2002

(54) THERMOFORMING APPARATUS FOR THERMOFORMABLE MATERIALS IN RIBBON OR SHEET-FORM

(76) Inventor: PIETRO PADOVANI, VERONA (IT)

Correspondence Address: RICHARD P BERG, LADAS & PARRY, 5670 WILSHIRE BOULEVARD, SUITE 2100, LOS ANGELES, CA, 900365679

(21) Appl. No.: 08/809,340

(22) PCT Filed: Sep. 1, 1995
(86) PCT No.: PCT/EP95/03451

(30) Foreign Application Priority Data
Sep. 14, 1994 (IT) VR94A000082

(51) Int. Cl. B29C 51/44

(52) U.S. Cl. 425/388; 425/403.1; 425/422; 425/436 R; 425/436 RM

(57) ABSTRACT

A thermoforming apparatus comprising a thermoforming machine (10) having a female die (12) and counter-die or male die (13) reciprocally approachable and removable for the operations of closing, thermoforming and opening, a feeder of thermoforming material between the female die (12) and counter-die (13), cutting means for cutting the thermoforming material immediately after the closure of the female die and the counter-die, one or more work or treatment stations for the articles (15) thermoformed in the die (12), extraction heads (16) arranged to be operated concomitantly with each opening of the same to extract a thermoformed article (15) moulding from the female die and to convey the articles thus extracted to one or more work or treatment stations or else to transfer them to a receiving template (17), retention means for engaging each thermoformed article (15) with the respective extraction head or else with its respective receiving template to ensure correct positioning of the article during conveyance through the work or treatment stations.

This invention generally relates to a thermoforming apparatus for thermoformable materials in ribbon or sheet-form.

As is known in the art—see for example the U.S. Pat. No. 1,175,178 and U.S. Pat No. 1,218,634—it has already been suggested to extract mouldings of thermoformed objects from a female die by using suction plates which are introduced between the male die and the female die of a thermoforming machine and then successively move away from the moulding area to deposit the articles onto an extracting or removal means for a series of intervening operations on the articles, such as stacking, labelling, etc.

Also already proposed has been a thermoforming machine with a double female die arranged to be actuated in alternate transverse motion in relation to a male die, in which two suction hoods alternately extract a thermoformed-article moulding from a respective female die, to transfer it in sequence to a perforated jig forming part of a step conveyor having a plurality of jigs, each of which has holes dimensioned and arranged like the female cavities of the female dies where the articles were thermoformed. The conveyor is operatively connected to the thermoforming machine and moves at the pace of the operating rate of the thermoforming machine, and is intended to receive the articles immediately after the thermoforming process, to support them in the same reciprocal set as they occupied in female die, in order to prolong the time for the stabilisation of the material just thermoformed and allow the regular feeding of the thermoformed articles to a series of operating stations for intervention on the articles. Reference should be made to applicant's Italian patent application no 92A000012 filed Feb. 3, 1992 and entitled: “Process and apparatus for the thermoforming and stacking of hollow bottom-provided articles obtained from a ribbon of thermoplastic material”.

U.S. Pat. No. 4,464,329 (Whiteside et al) discloses a thermoforming machine in which the plates of a plate-conveyor pass between a male die and a female die and are pressed between the two dies during the closure phase of the die and co-operate with an intermediate auxiliary die, which is mobile in relation to the female die. Each plate or jig is fitted with receiving seat for a moulded article and around the peripheral contour of such seat is provided a ring gasket of flexible material which serves to resiliently engage and keep the thermoformed article restrained in its position whether during the extraction of the article from the female die or during its transfer to an unloading station or removal from the conveyor.

The solutions proposed up to now, although satisfactory from many points of view, have not provided for the thermoformed article or articles to be held fast to a receiving template or jig forming part of the step conveyor operatively connected to the thermoforming machine, in which case, the thermoformed and not yet stabilized articles can undergo inertial shifting or removal from their reception seats, whereby they can lose the required precision of their positioning for successive operations or interventions on them.

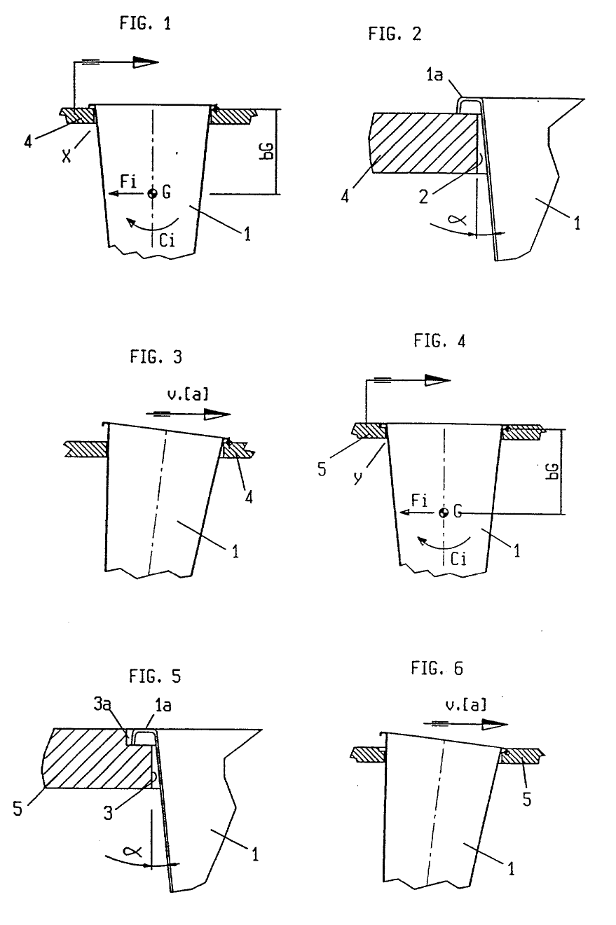

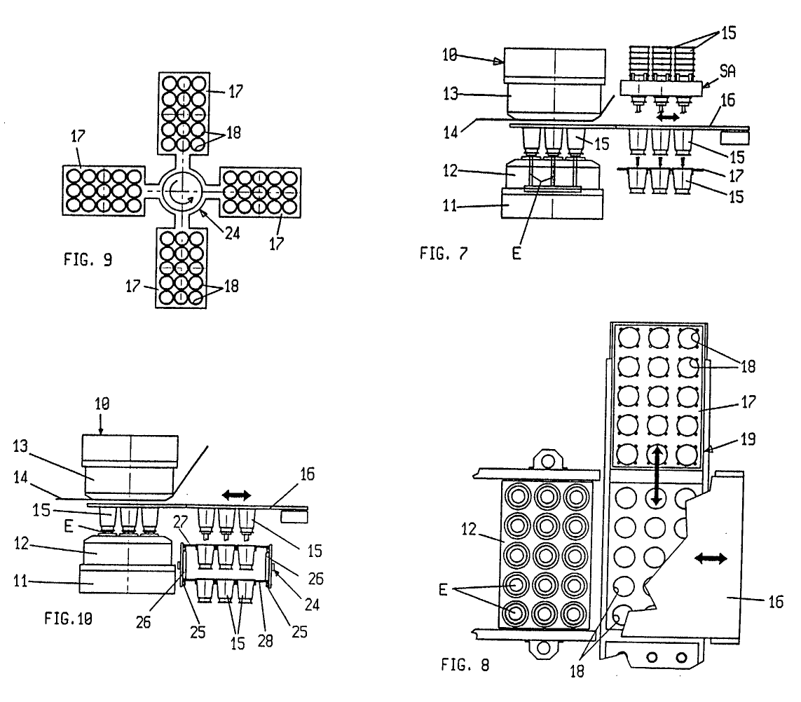

It can be seen, in fact, in FIG. 1 to FIG. 6 in the accompanying drawings show a truncated conical container with protruding rim such as a beaker 1, deposited in two different seats (through-holes) 2 and 3 (which latter is fitted with a peripheral recess 3a against which the rim 1a of the container can abut provided in a respective transfer plate or jig 4 and 5. As each plate or jig is speedily moved at the pace of the rate of operation of the thermoforming machine which produces the articles, the articles in the jig are repeatedly subjected to acceleration both while being moved forwards and stopped. Since the centre of gravity G of each article 1 is outside the plane of the lying position of the jigs 4 and 5, whenever the article undergoes an acceleration, it also undergoes an upturning momentum which tends to make the article tilt in relation to the vertical in proportion to the arm bG (FIGS. 1 and 4). In view of the taper (angle α—FIGS. 2 and 5), such momentum can also give rise to a harmful banging either on the lateral wall of the container 1 in the process of stabilisation, or on its rim (FIGS. 3 and 6) as also to undesirable bedding outside the axis, which almost always compromise the good result of successive operations and interventions on the container which must maintain a correct, unvarying set, either during the step-by-step transfer or while stationed at the various work stations.

In the case of the solution suggested in U.S. Pat. No. 4,464, 329, the extraction operations of the die are not kept separate from the positioning operation of the transfer plate or jig, the reason why recourse must be made to a three-piece die (male, female and auxiliary intermediate die) extremely complicated and costly to make and mobilize. Moreover, in the Whiteside et al. solution, during the moulding phase, the ring gasket is kept in contact with the hot edges of the thermoforming die, and thus the gasket is subjected to repeated thermal cycling, undergoes rapid ageing and loss of flexibility, and after a limited number of thermoforming cycles, can stiffen until it causes scoring or another form of damage to an article which has just come out of the thermoforming die and is not yet fully stabilized, and thus undoubtedly increasing the number of rejects (unless special and consequently very expensive material is used).

The main object of the present invention is to eliminate or drastically reduce the drawbacks often complained of in the thermoforming apparatus, thereby allowing either a rapid extraction of the thermoformed articles from the die or seating them in a stable set on templates or jig for successive removal and transfer to one or more treatment and/or work stations.

Another object of the present invention is to provide available a thermoforming apparatus fitted with a step conveyor with templates or jigs for receiving the articles just extracted from the thermoforming dies and in the process of stabilisation, to enable them to be transferred to a plurality of work stations, while keeping their set intact.

These and further objects, which will become more apparent later, are achieved with a thermoforming apparatus comprising a thermoforming machine fitted with at least one female die and counter-die or male die reciprocally approachable and removable for the operations of closing, thermoforming and opening, a feeder suitable for feeding thermoforming material in ribbon or plate form between each die and counter-die, cutting means associated with the die and counter-die for cutting the ribbon or plate material immediately after the closure of the die and counter-die, at least one work or treatment station for the articles thermoformed in the or each die and counter-die, a plurality of extraction means to extract a thermo-formed article moulding from the female die and move away from the die to convey the extracted articles successively to the or each work or treatment station, or else to transfer it to a receiving template for being conveyed to the or each work or treatment station or stations, retention means suitable for engaging each thermoformed article with the respective extraction head or else to its respective receiving template, thus ensuring its positioning in the correct set during conveyance through the work or treatment station or stations.

Further aspects and advantages of the present invention will become more apparent from the following detailed description of some of the currently preferred embodiments thereof, given by way of indicative, although not exclusive examples only, with reference to FIGS. 7 to 53 of the accompanying drawings, in which:

FIG. 7 is a schematic lateral elevation of a thermoforming machine provided with an extraction plate for the thermoformed articles and with an alternatingly moving conveyor having two coplanar templates;

FIG. 8 is a partial top view of the female die of the thermoforming machine, the conveyor and the extraction plate of FIG. 7;

FIG. 9 is a top view illustrating a carousel variant with four arms;

FIG. 10 shows in schematic section and lateral elevation view a thermoforming machine fitted with extraction plate for thermoformed articles and with a chain conveyor (with despatch and return runs, parallel but moving in opposite direction) fitted with article receiving templates, moving in sequence, first in one direction (forward run) and then in the other (return run);

FIG. 11 illustrates a partial top view of the female die of the thermoforming machine, the conveyor and the extraction plate of FIG. 10;

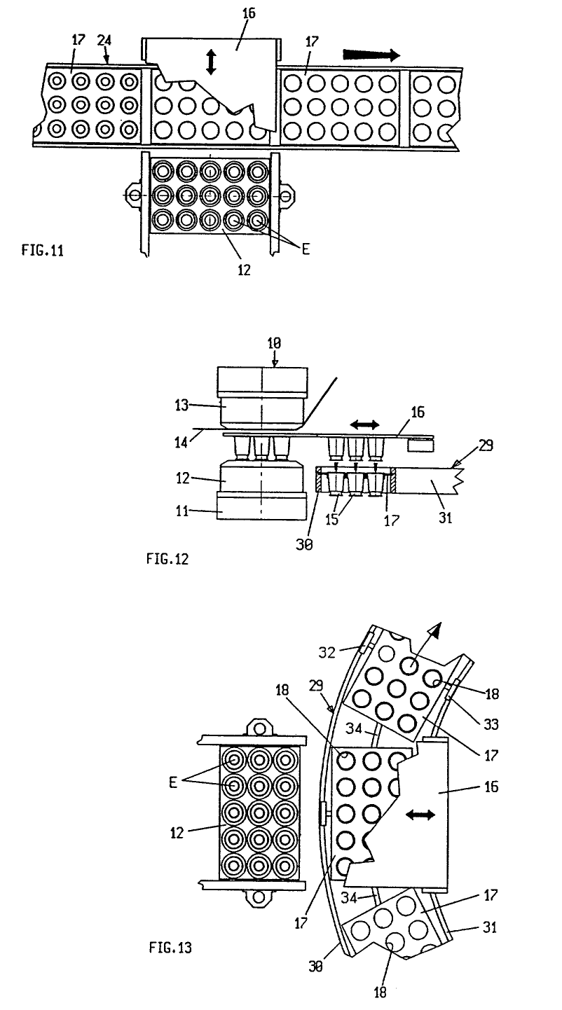

FIGS. 12 and 13 are, respectively, a lateral elevation view and a top section similar to those of FIGS. 10 and 11, but with a conveyor with templates mounted and trailed along two circular, coaxial and coplanar trackways;

FIGS. 14 and 15 are, respectively, a lateral elevation view and a top section similar to those in FIGS. 10 and 11, but with a carousel conveyor with three plates or templates which act either as extraction plates for the die or as conveyor;

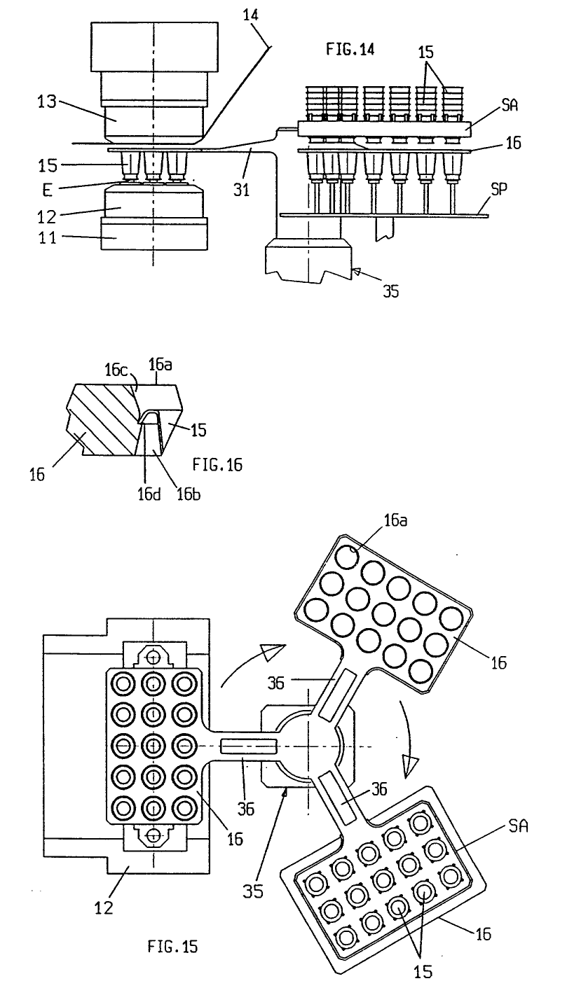

FIG. 16 shows a detail of a receiving seat for a thermoformed-article, provided in a template;

FIG. 17 is a schematic front elevation view which illustrates a thermoforming machine with conveyor with templates mounted on chains, where the conveyor templates also act as extraction plates for the articles thermoformed by the die;

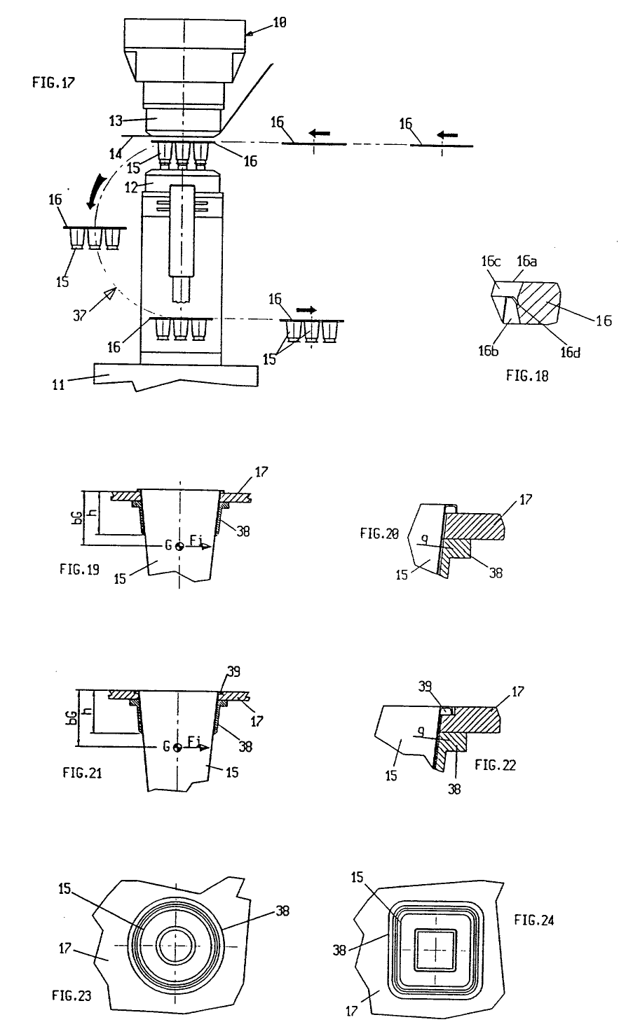

FIG. 18 shows a detail in a magnified-scale of the conveyor template of FIG. 17;

FIG. 19 is a partial sectional view of a conveyor template with seat provided with retention collar and container seated therein;

FIG. 20 illustrates a detail of the template of FIG. 19 to an enlarged scale;

FIG. 21 illustrates a partial sectional view of another conveyor template similar to that in FIG. 19, but also formed with an annular recess for receiving the rim of the container;

FIG. 22 illustrates a detail in section and to an enlarged scale of FIG. 21;

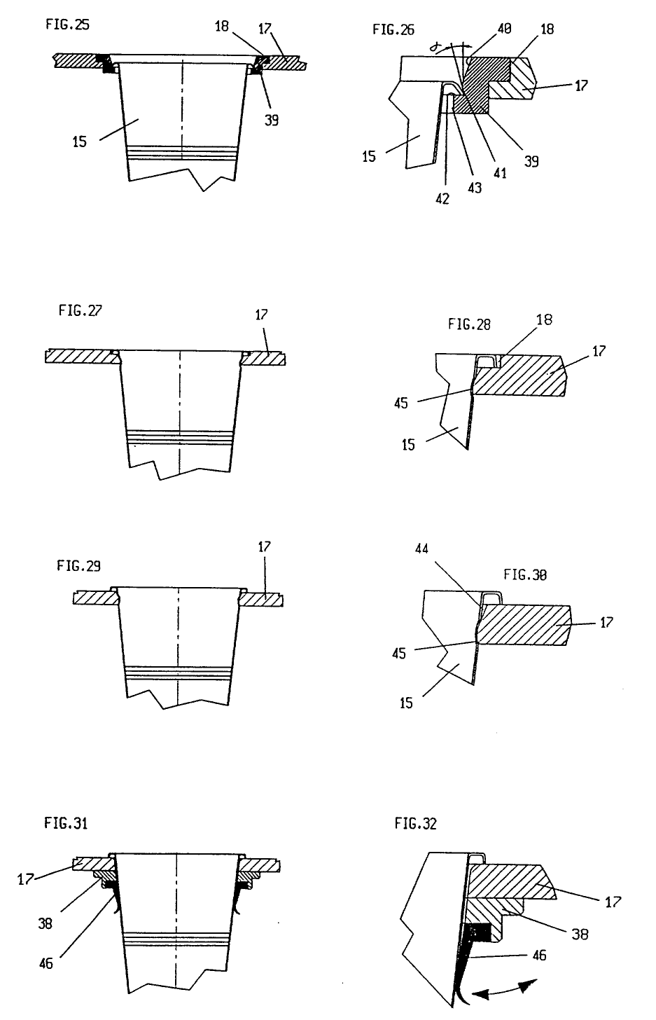

FIGS. 23 and 24 are top views illustrating possible shapes in circular, rectangular or quadrate topview of the container of FIGS. 19 and 21;

FIG. 25 is a local sectional view which shows another embodiment of a template seat for thermoformed articles;

FIG. 26 shows a sectional detail of FIG. 25;

FIG. 27 shows a sectional view of a further embodiment of a seat for a receiving template for thermoformed articles;

FIG. 28 illustrates a detail of FIG. 27;

FIG. 29 is a sectional view showing a template with a receiving seat provided with an adapter collar for retaining the container;

FIG. 30 shows a detail of FIG. 29;

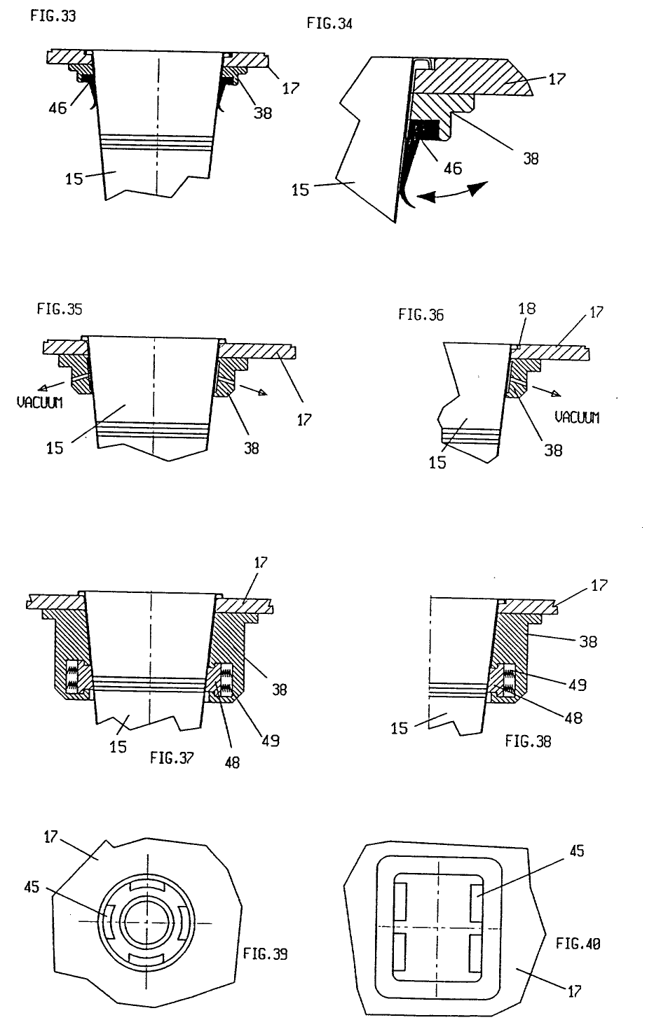

FIGS. 31 and 33 and the respective details of FIGS. 32 and 34, illustrate two embodiments of a conveyor template fitted with resilient means of restraint for thermoformed articles;

FIG. 35 illustrates a partial sectional view of a receiving seat for a thermoformed article in a conveyor template with vacuum retention means;

FIG. 36 shows a variant of FIG. 35;

FIG. 37 is a sectional view showing a receiving seat of thermoformed articles fitted with resilient retention means;

FIG. 38 shows a modification of FIG. 37;

FIGS. 39 and 40 are topviews illustrating a circular and a rectangular shape of thermoformed article of FIGS. 37 and 38;

FIG. 41 shows a partial sectional view of another embodiment of a receiving seat for thermoformed articles of a conveyor template provided with mechanical retention means;

FIGS. 42 and 43 show details and variants of the plate or template of FIG. 41;

FIGS. 44 and 45 are topviews illustrating a circular and a rectangular shape of thermoformed article installable in the plates of FIGS. 41 to FIG. 43;

FIGS. 46 and 47 show two jig seats for a template conveyor slat for thermoformed articles with pneumatic means for retention in position;

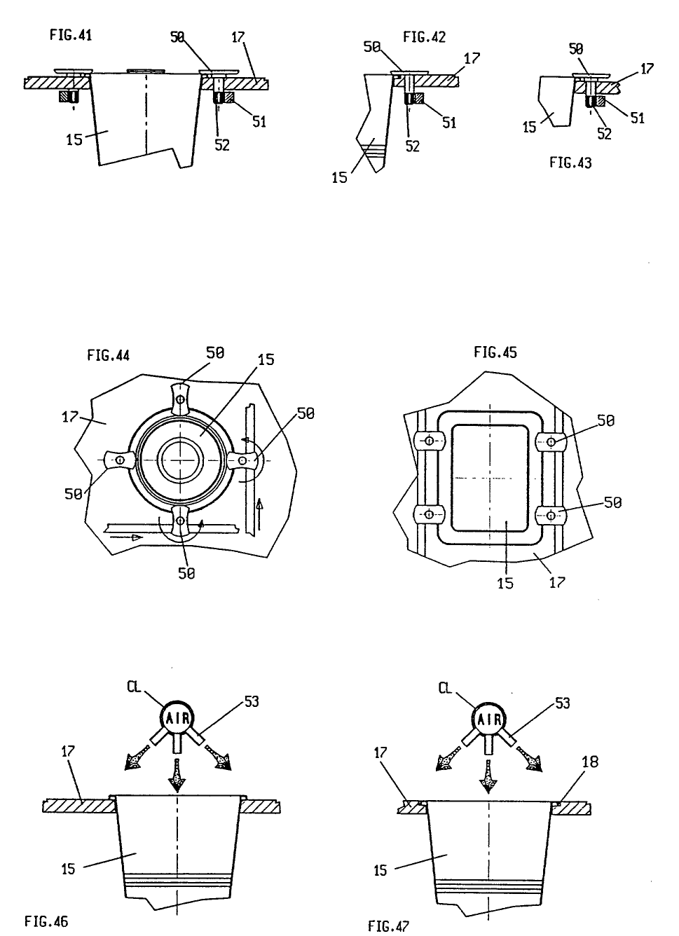

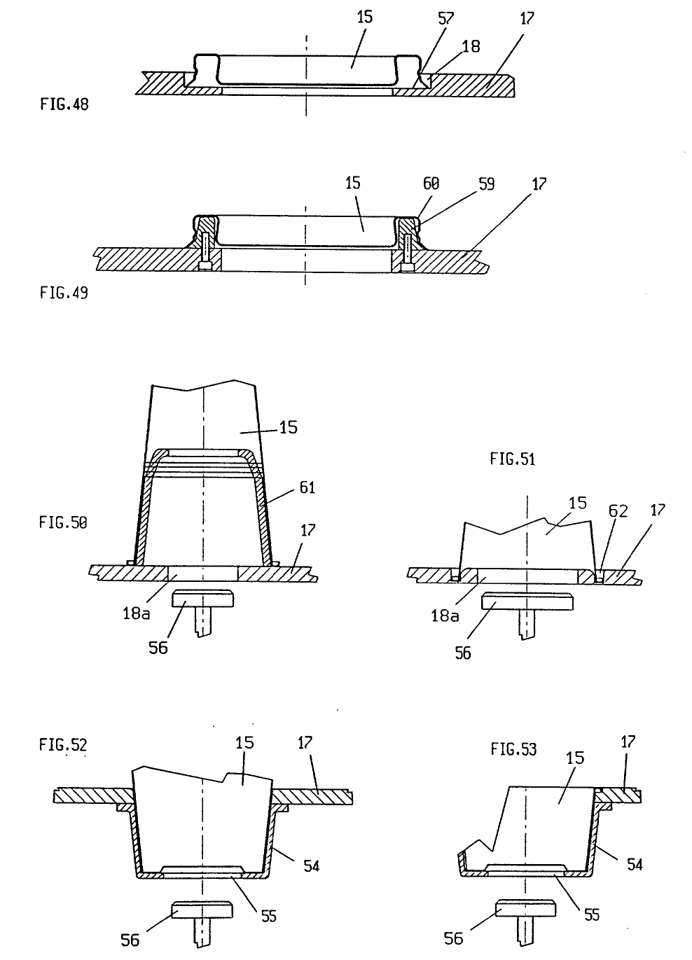

FIGS. 48 and 49 show two partial sectional views of two different embodiments of a receiving seat for a thermoformed cover in a conveyor template;

FIG. 50 shows a receiving seat of a conveyor template comprising a raised push rod;

FIG. 51 shows a partial sectional view of a receiving seat with bearing recess for the rim of a thermoformed article;

FIG. 52 illustrates a partial sectional view of a receiving seat in a conveyor template for thermoformed articles; and

FIG. 53 shows a variant of FIG. 52.

In the accompanying drawings, the same or similar parts or components have been marked with the same reference numerals.

With reference first to the embodiment illustrated in FIGS. 7 and 8, schematically indicated by 10 is a thermoforming apparatus which comprises a base 11 on which is mounted a vertically mobile female die 12. Above the female die 12 there is provided, as is usual in thermoforming technology, a male die or counter-die 13, which in its turn, can be lowered and raised in relation to the female die and synchronously with it, to allow implementation of the required operations of closing and opening of the die, as well as cutting of the thermoformable material in ribbon or plate 14 being supplied by any suitable means between the dies 12 and 13 when they are in the open position.

The articles 15 (usually containers—beakers, cups, basins, lids and the like) obtained by thermoforming within the female die 12, after the opening or reciprocal removal of the dies 12 and 13, must be withdrawn from the female die, which operation being facilitated by the provision of the extraction members E (one for each thermoformed article) rising from the base of the female die during the opening phase of the dies. The articles are detached from the die 12 using an extraction plate 16, for example, a suction plate as described in Italian patent no 1 175 178 and no 1 218 634 referred to above, which is actuated in phase with the removal rate of the dies 12 and 13 and extracts all the moulding articles present in the female die 12 and transfers them onto a jig or template 17 fitted with so many reception seats of holes 18, equivalent in number to the articles 15 constituting a moulding.

The templates 17 belong to a conveyor 19 with two templates alternately movable, once onto one side of the die 12 and once onto the other, so that a template is moved laterally in relation to the female die, while the other is in front of it ready to receive an article moulding from the extraction plate 16. In their lateral position, the templates 17 deliver the articles 15 to a handling and/or treatment station, for example, a sterilisation and stacking station for the articles.

The embodiment of FIG. 9 relates to a carousel conveyor 20 comprising of four templates 17 positioned at 90° angles, to revolve in a pre-set direction of rotation for sequential positioning under extraction plate 16, to receive from it a moulding of articles 15 to be transferred.

FIGS. 10 and 11 illustrate an embodiment in which the templates 17 are positioned under a step conveyor 24 comprising two chains 25 which turn around respective chain wheels 26 at the ends of the conveyor and spanning which are mounted a plurality of templates 17 which are then arranged in an upper run 27 immediately below the operating path of the extraction plate 16 and a lower one 28, which moves in the opposite direction to the upper one. There can be provided a multiplicity of work and/or handling stations for the articles 15 arranged on the templates alongside the conveyor 25 both along its upper run 27 and its lower run as well as at end wheels 26.

The variant shown in FIGS. 12 and 13 concerns a conveyor 29 comprising a single run, level but circular in shape, suitable for moving a plurality of templates 17 in sequence making them revolve stepwise, all in the same direction, under the extraction plate 16.

If desired, each template 17 can be easily mounted on a pair of fixed, circular, lateral trackways 30 and 31, for example, by means of two slides or carriages, respectively 32 and 33, and is restrained, typically by cable or chain or a suitable linkage means 34, either to the template preceding it or to the one following it on the circular conveyor 29. The template train is of course drawn in rotation by a step motor at a pace which will make the various templates stand in turn under the extraction plate 16.

The embodiment shown in FIGS. 14 to 16 relates to a carousel conveyor 35 with three arms 36, 120° apart, each of which supports a extraction plate 16 at its end. Each extraction plate 16, therefore, sequentially moves into three different operating positions, that is to say, one for extraction from between the opened dies 12 and 13, an intermediate one, where for example, the articles 15 are labelled or bored or otherwise processed or machined at a particular work station (not shown in the drawings), and a terminal (all positioned along the path of the extraction plate 16), where the same articles 15 are, for example, stacked in a stacking unit SA similar to that of FIG. 7.

As can be seen looking at FIG. 16, the extraction plates 16 can also be of a different type from the suction one and can have receiving holes 16a machined along their thickness in order to present two annular inclined-plane surfaces 16a and 16b which delimit between them an equatorial shoulder 16d with an internal angle slightly undercut to be able to engage and firmly hold in position the free rim of a respective article 15.

The latter, while being raised by the extractor members E, is pushed to slide with its rim along the tapered surface 16b and to snap into engagement position with the shoulder 16d, and then conveyed along the operation path comprising the intermediate and the final station for the respective extraction plate 16. When at the final station, a slight thrust on the base of the container by a suitable thrusting device SP. (FIG. 14) will free the container from its receiving seat to then move to the stacker unit SA.

A similar structure is that illustrated in FIGS. 17 and 18, in which a plurality of extraction plates such as those in FIGS. 14 to 16 are mounted on a chain conveyor 37 of the type of conveyor 24, in which a run, for example, the upper run, extends between the dies 12 and 13 when they are in the open position and carries in step sequence the various plates 16, to be loaded with articles which are then carried in sequence to a predetermined number of work or handling stations.

FIGS. 19 to 24 illustrate a template 17, which, at each receiving hole 18 has in its far surface far from the extraction plate 16 a tapered collar 38, in which the articles 15 can precisely fall into seated position where they can thus abut with their rim either directly against the other surface of the template (FIGS. 19 and 20) or with a suitable annular recess 39, which assists in providing greater stability and accuracy in holding the articles 15 of both circular and square or rectangular topview configuration in the correct set.

As can be seen, in fact, the upturning momentum due to the arm bG and the inertial force at the centre of gravity G of the articles 15 is completely neutralized by shape engagement provided by the collar 38 and the thickness of the template having a total height h. In its turn, the height h is determined as a function of both the shape of the article 15 and the clearance g between the wall of the article and the internal diameter of the respective receiving seat 16a.

The embodiment shown in FIGS. 25 and 26 concerns an adaptor collar 39 installable in each two-diameter receiving hole 18 a template 17 and having an internal diameter delimited by a higher tapered section 40, by an undercut intermediate section 41 with a negative angle α, for example, from 3° to 10°, preferably, of approximately 5°, by an annular shouldering 42 at the undercut section, followed by a cylindrical end section 41. The articles 15 released by an extraction plate 16 are placed between a respective collar 39 and at their rim, slide along the tapered section 40 until they snap engage with the tapered section 40, in which they remain “resiliently constrained” in the correct position.

The templates 17 of FIGS. 27 to 30 have holes 18 fitted with a receiving tapered upper portion 44 and connected lower portion 45, but with an internal diameter slightly smaller than the external dimensions of the article 15 in the proximity of its rim. Also, in this case, the article 15 is “resiliently constrained” and therefore settled in stable fashion within the respective receiving hole, from which it can be upturned solely by the exercise of a sufficient thrust from below upwards.

Since there is no clearance g between the internal diameter of the receiving seat 18 in the template 17 and walls of the article 15, it is not necessary to provide any collar means to increase the thickness of the template 17.

The embodiment of FIGS. 31 to 34 is similar to those of FIGS. 19 to 22, except that the lower part 46 of the collar 38 consists of a deformable resilient material, suitably anchored to the collar and designed to exert a moderate pressure on the external surface of the article.

FIGS. 35 and 36 show holes for a vacuum pneumatic circuit (not shown and communicating with a suitable suction means) formed in the collar 38 and having the function of maintaining the thermoformed articles 15 in a stable set.

FIGS. 37 and 38 illustrate suitably shaped ratchets 48 installed in a collar 38 fitted at a preset distance from the template 17, in order to be able to move radially or otherwise along a transverse plane (preferably perpendicular) with respect to the axis of the respective article 15 to be locked in position. The ratchets 48 are resiliently loaded, for example, by one or more springs 49.

FIGS. 39 to 45 show eccentric mechanical retainers 50, each of which is mounted at a respective receiving hole 18 on a template 17, and is movable, for example, by rotation around an axis normal to the template 17 to which it belongs, between an operating position in which it engages the rim of an article 15 and an inoperative release position. Actuation of the retainers 50 can be effected by means of a rack operated by a suitable motion source, such as a pneumatic jack, and an integral pinion 52 in rotation with a respective retainer 50.

Embodiment examples of FIGS. 46 and 47 concern retention means, generating air—jets 53 through a manifold CL, which exert a thrust pressure on the article 15 in correct set in the respective receiving seat 18 and with their rim abutting against the template 17.

Means of retention in position for covers 15 are illustrated in FIGS. 48 and 49 and comprise a bearing shouldering 57 in each receiving seat 18, which has two diameters, or else an annular protrusion 59 which engages the internal diameter of the flange 60 of the cover (FIG. 49).

FIGS. 50 and 51 show retention means for articles 15 kept inverted during transfer to the various work or treatment stations. FIG. 50 illustrates a sort of push rod 61 which rises from a surface of the templates 17 at a dummy receiving seat 18a, while in FIG. 51 the dummy receiving holes 18 annular slots 62 are provided, with which the free rim of an inverted article 15 will abut. The removal is effected, for example, by means of a push rod 56.

FIGS. 52 and 53 illustrate cup retention means 54 with an orifice 55 at the base. The cup 54 is applied in similar way to a collar 38, to correspond with each receiving hole 18 of a template 17 for receiving and completely compassing an article 15 (even if not provided with a flanged or curled rim), thus preventing any lateral shift, but with the possibility of easily expelling it from the cup 54 by acting with a push rod 56 through the orifice 55.

As will be seen with the technical solution, in accordance with the present invention a sure, steady, uniform positioning of the articles for an indefinite series of mouldings is ensured, so that on the same articles while they are in the process of stabilization, a certain number of finishing and/or embellishment operations with great precision and without turning out rejects.

The invention described above is susceptible to numerous modifications and variations within the protective scope of defined by the purview of the claims.

1. A thermoforming apparatus comprising
a thermoforming machine (10) fitted with at least one female die (12) and counter-die or male die (13) reciprocally approachable and removable for the operations of closing, thermoforming and opening, a feeder appropriate for feeding thermoforming material in ribbon or plate (14) from between each female die (12) and counter-die (13),
cutting means associated with the die and counter-die for cutting the ribbon or plate material, immediately after the closure of the die (12) and counter-die (13),
at least one work or treatment station for articles (15) thermoformed in the or each die (12) or counter-die (13),
extraction pick-up means (16) designed to withdraw a thermoformed article moulding from the female die (12) and either to convey the same to at least one work or treatment station or to transfer it to a receiving conveying template (17) which has the same seating configuration as that of the female die (12) and is arranged to move the thermoformed articles (15) past at least one work or treatment station,
characterised in that retention means are provided in the said extraction pick-up means and/or in the said receiving conveying template to hold them in position against undesired movement therein.

2. A thermoforming apparatus as claimed in claim 1, characterised in that the said pick-up extraction means comprises a plate-like head (16) arranged to be sequentially inserted between the or each female die (12) and counter-die (13) concomitantly with each opening of the same.

3. A thermoforming apparatus as claimed in claim 2, characterised in that it comprises a carousel conveyor (20) with a plurality of bearing arms, each of which supports a respective plate-like head (17) fitted with said retention means for the retention of the thermoformed articles (15) in the correct set while they are being conveyed, stepwise and synchronously with the opening-closing rate of the dies through the work or treatment station or stations, positioned around the carousel conveyor.

4. An apparatus as claimed in claim 3, characterised in that the said retention means for each plate-shaped extraction head (17) comprises a hole or seat through the said plate-shaped extraction head for each thermoformed article to be extracted, each hole being machined along its thickness to obtain two annular surfaces reamed in opposite directions and delimiting between them an equatorial shoulder (16d) with a slightly undercut, internal angle of incidence, in order to allow insertion by the thrust of a rimmed thermoformed article (15) and enable it t to be resiliently constrained and held firmly in position at its rim.

5. A thermoforming apparatus as claimed in claim 2, characterized in that it comprises a chain or chains conveyor (24) each wound by a pair of chain wheels and having a run (27) thereof extending along the respective die (12) or counter-die (13) but beyond the encumbrance thereof, a plurality of extraction plates (16) carried at predetermined intervals from each other on the said conveyor (24) and each fitted with the said retention means for retaining the thermoformed articles (15) in the proper set during their conveyance.

6. A thermoforming apparatus as claimeden claim 1 or 2, characterized in that it comprises a template conveyor (24) extending through the work or treatment station or stations and moving stepwise at the opening-closure rate of the dies (12) for receiving a moulding or thermoformed articles (15) from an extraction plate (16) and conveying them in sequence to the work or treatment station or stations along the template conveyor (24).

7. A thermoforming apparatus as claimed in claim 6, characterized in that the said template conveyor (24) comprises two alternately movable templates (17), once on one side of the die (12) and once on the other, so that a template (17) is moved laterally in relation to the female die (12) at a work or treatment station, while the other one is in front of it to receive an article moulding from the extraction plate (16).

8. A thermoforming apparatus as claimed in claim 6, characterized in that the said template conveyor (24) is a chain or chains conveyor which comprises a pair of chain wheels (26) around which the or a respective chain (25) is wound, a plurality of plate-like templates (17) carried, spaced at a predetermined distance from each other, on the said conveyor (24) and each fitted with the said retention means for retaining the thermoformed articles (15) in the proper set during their conveyance.

9. A thermoforming apparatus as claimed in claim 5, characterized in that the said template conveyor (24) comprises a train of articulated bearing slides (32) or carriages (33) for a respective template (17) moving through the work or treatment station or stations.

10. A thermoforming apparatus as claimed in any of claims 6 to 9, characterised in that the said retention means on each template comprises a truncated conical collar (38) seated in each receiving hole for precise location of a respective thermoformed article (15) on the surface of each template (17) facing the extraction plate of plates (16).

11. A thermoforming apparatus as claimed in claim 10, characterised in that the said collar (38) is constituted of resiliently deformable material suitable for exerciting a moderate retentive pressure on the external surface of a thermoformed article (15).

12. A thermoforming apparatus as claimed in claim 10, characterised in that the said collar (38) comprises a plurality of resiliently loaded ratchets (48), installed in said collar and movable towards its internal diameter for engaging with the external surface of a thermoformed article (15) in a respective receiving seat.

13. A thermoforming apparatus as claimed in claim 10, characterised in that the said collar (38) comprises suction orifices which exert on the thermoformed article (15) a suction action to hold it in the proper set in its respective receiving seat and with its rim abutting against the template (17).

14. A thermoforming apparatus as claimed in any of claims 10 to 13, characterised in that each template (17) at each flanged receiving set for thermoformed rimmed articles (15) has a peripheral recess formed on the surface of the template (17) facing the extraction plate or plates (16) for engaging the rim of a respective article (15) installed in it.

15. A thermoforming apparatus as claimed in any of claims 6 to 9, characterised in that the said retention means for each template (17) comprises a two-diameter adaptor collar (39) installable in each receiving seat and having an internal diameter delimited by a tapered under section, and undercut intermediate section with a negative angle α, an annular shoulder downstream of the undercut section, to be able to receive from above a flanged thermoformed article (15) and snap-engage its rim at is undercut.

16. A thermoforming apparatus as claimed in any of claims 6 to 9, characterised in that the said retention means for each template (17) comprises receiving holes for the thermoformed articles lower portion, but with a slightly smaller internal diameter than the external dimensions of the thermoformed articles (15) to be received close to its rim, so that the thermoformed article (15) is resiliently constrained and then steadily bedded in the respective receiving hole.

17. A thermoforming apparatus as claimed in any of claims 6 to 9, characterised in that the said retention means of each template (17) comprises eccentric mechanical arrests (50), each of which is fitted at a respective receiving hole of a template (17) and is movable between an operating position in which it engages the rim of a flanged thermoformed article (15) and an inoperative releasing position.

18. A thermoforming apparatus as claimed in claim 17, characterised in that the said arrests are controlled by a rack operated by a suitable motion source.

19. A thermoforming apparatus as claimed in any of claims 6 to 9, characterised in that the said retention means comprises air jets (53) for sinking each of the articles (15) into the receiving holes on each template (17).

20. A thermoforming apparatus as claimed in any of claims 6 to 9, characterised in that the said retention means comprises a cup-shaped receiving component (54, 61) for a thermoformed article (15) having at least one orifice in its base.

21. A thermoforming apparatus as claimed in claim 21, characterised in that it comprises a push rod (56) for expelling the thermoformed article (15) from the cup-shaped component (54, 61) by acting through at least one orifice (55) in the bottom of the cup-shaped component.

22. A thermoforming apparatus as claimed in any one of claims 6 to 9, characterised in that the said retention means comprises a support shoulder for shallow, thermoformed articles arranged between each receiving seat of the template (17), the said shoulder having two diameters or else including an annular projection which engages the internal diameter of the rim of the article.

23. A thermoforming apparatus as claimed in any of claims 6 to 9, characterised in that the said retention means comprises a push-rod which rises from a surface of each template (17) to a respective dummy receiving seat.

24. A thermoforming apparatus as claimed in any of claims 6 to 9, characterised in that the said retention means comprises at least one annular recess, in which the free rim of an upturned hollow article (15) abuts and a movable push road (56) for removal of the article (15).
